(19) United States
(12) Patent Application Publication
(10) Pub. No.: US 2019/0139288 A1
(43) Pub. Date: May 9, 2019

(54) DYNAMIC MOTION SIMULATION METHODS AND SYSTEMS

(71) Applicant: MICHAEL KELLY, PERTH (CA)

(72) Inventor: MICHAEL KELLY, PERTH (CA)

(21) Appl. No.: 16/097,294

(22) PCT Filed: Apr. 27, 2017
(86) PCT No.: PCT/CA2017/000105

§ 371 Date: Oct. 29, 2018

Related U.S. Application Data
(60) Provisional application No. 62/330,288, filed on May 2, 2016.

(51) Int. Cl. G06T 13/40; G06T 7/246; G06F 3/0484

(52) U.S. Cl. CPC G06T 13/40; G06T 2207/30241; G06F 3/04847; G06T 7/251

(57) ABSTRACT

Articulated assemblies are all around us in nature as well as within the artificial environments and artificial systems we create. Computer based simulations are used to view, analyze, and modify motion specifications and sequences for articulated assemblies in the generation of avatars for multimedia and designing robotic/android systems. Articulated assembly specifications along with terrain and physical laws are employed in establishing an actuation and motion sequence for the assembly. However, other factors such as emotion, state of mind, etc. impact how the assembly actually moves and the physical aspect of the assembly. Embodiments of the invention allow for management of cyclic and acyclic elements to the overall motion through graphical user interfaces as well as the rapid establishment of new motion models through fractional combination of existing motion models as well as the association of a motion model to multiple articulated assemblies allowing simulations of herds, crowds etc.

### CROSS-REFERENCE TO RELATED APPLICATIONS

This patent application claims the benefit of priority from Patent Cooperation Treaty Application PCT/CA2017/000,105 filed Apr. 27, 2017 entitled “Dynamic Motion Simulation Methods and Systems” which itself claims priority from U.S. Provisional Patent Application 62/330,288 filed May 2, 2016 entitled “Dynamic Motion Editor”, the entire contents of which are herein incorporated by reference.

### FIELD OF THE INVENTION

This invention relates to the design and simulation of articulated assemblies, such as robots or animated characters, and more specifically to the model used to represent motions of such assemblies, and to systems and methods for viewing, analysing, and modifying of such models.

### BACKGROUND OF THE INVENTION

Articulated assemblies are comprised of rigid or flexible segments of arbitrary shape, and the joints between them. Segments may additionally have mechanisms attached to them which will affect the way the segment will interact with an obstruction, a support surface, or other segments. For example, a segment may have a wheel or track mechanism at one end to provide control of the endpoint when it is in contact with a support surface instead of relying on the static physical properties of the segment and the support surface such as static and dynamic coefficients of friction. Assemblies may be or contain tree-shaped structures of connected segments. Assemblies may be or contain loops of connected segments. Assemblies may include specifications for passive driving elements such as springs and dampers. Assemblies may include specifications for active driving elements such as motors. Assemblies may or may not be anchored to an immovable reference point. An example of an unanchored assembly is a free-standing legged robot whilst an example of an anchored assembly is a manufacturing robot arm fastened to a workstation bench.

Representations of articulated assemblies, desired motions for them, the terrain over which they will move, and the physical laws which motion should obey are the four elements central to the design and simulation of actual motion sequences of those assemblies, and the actuations of the active driving elements of those assemblies to produce the desired motions.

In a design system, topological representations of articulated assemblies are constructed by specifying the individual bodies, or segments, in the assembly and the joints between those segments. The properties and behaviors of the segments and joints in the assembly may be specified as part of the design process, or separately in a different design system at the same or other time. Properties of segments may include, for example, geometry and mass, and may include any such properties of the assembly that might affect its actuations or the resulting motions. Properties of joints include the number and nature of the degrees of freedom for each joint, and may include, for example, limits on motion, a spring constant, and maximum force or torque values for active drivers associated with a degree of freedom. The design stage may be a precursor to constructing or modifying a physical assembly.

In the same or different design system, terrain properties are specified. The specification may contain, for example, i) spatial information, such as the altitude and slope of the terrain at each point, and the presence of steps, ii) material information, such as the static and dynamic coefficients of friction and the spring constant representing the elasticity at each point on the terrain, iii) fluid cover information, such as the depth of fluid, its density, its viscosity, and its velocity at each point on the terrain, and iv) obstruction information, including immobile objects such as building and trees, or mobile objects such as vehicles or other assemblies, which may or may not completely prevent an assembly from occupying the same space as the obstruction.

In the same or different design system, motions for an articulated assembly are specified. The specification may contain, for example, i) spatial information, such as the path to follow for the motion, ii) behavioral information, such as the speed at which motion should occur, iii) timing information such as time instants at, or intervals during which, an event should occur, or time intervals over which a given motion or portion of the motion should occur, and iv) information about cyclic or acyclic motion elements to be superimposed on a base motion. The motion specification may include elements at different levels of detail. An example of a high-level specification is that a legged assembly's overall motion should be to walk, skip, run or hop. An example of a low-level specification is an exact path in space and time to be followed by the assembly, one of its segments, or indeed one point on one of its segments. The motion specification may also include actuations of driving elements, for example the application of a given torque at a given joint for a particular time interval.

Motion specifications will often, but not always, be associated with a legged gait. The elements making up a motion specification may be cyclic or acyclic. The elements making up a motion specification may include:
elements associated with individual or concurrently moving assembly elements, such as the flexing of an ankle, the swinging of a leg, or the swivel of the hips;
combinations of individual elements, such as the opposing swing of arms and legs, or the pulling in of the arms to do a pirouette;
combinations of individual or combination element qualities that can be characterized as a type of motion, such as lethargic, which is slower and less pronounced, happy, which has head held high and a step with a skip in it, or angry which has fists clenched, arms rigid, and shoulders canted forward, and
a set of measures indicating how much of each of the above are present, such as a walk which is 75% angry and 25% lethargic meaning, for example, that the angry walk is slower and the assembly has fists which are not as tightly clenched.

Acyclic elements may be deviations from or additions to the cyclic motion. Cyclic elements may be viewed as a complex curve which repeats, or as the frequency components of such a curve, as are extracted using a Fourier transform.

The content of a motion specification may be provided in different ways. It may be entered or read in textually or via options chosen from a menu, it may be generated using a graphical interface, for example using an electronic version of an assembly as a marionette, or it may be derived from a motion capture of a physical assembly, possibly a living being. In the case of motion capture information, it may be or have been modified before being supplied as input to the current invention.

In the same or different design system, the physical laws of motion to be obeyed by the assembly may be specified. These may or may not be the same physical laws governing our real world. For example, gravity or spring forces may vary as defined by a square law, as in the real world, or they may vary according to powers other than 2. As another example, forces or torques may influence objects linearly, via equations such as F=ma or τ=Iα, or according to a power other than 1. Alternatively, properties of the simulated environment may have different rules of electromagnetism, gravity, etc.

The motion of an articulated assembly can be complex even for a simple assembly because the number of possible states is, at worst, the product of all of the possible states of the individual elements, and because a motion specification also includes an indication of a desired sequence of those states. Further, the human observer is sensitive to many aspects of motion, meaning that the specification of motion must both conform to the expectations of a viewer, and allow for artistic input so that motions of different character can be specified. Further still, and particularly when real physical systems are involved, e.g., the control of a legged robot, the laws of physics must be adhered to, within tolerances, so that realization of that motion can be done in a physically correct way.

In the current state of the art, motion specifications are captured in different ways:
hand-drawn poses associated with given time instants, i.e., key frames,
electronic marionette poses associated with given time instants, i.e., key frames,
electronic marionettes with cycles associated with the motions of some of the segments or joints.

In the third case, electronic marionettes, the current state of the art is insufficient to capture realistic detail:
a select few elements are considered candidates for cyclic motion;
a single frequency, that of the cycle of an entire stride of a walk, is used to specify motion;
there is no model of the motion which leads to representation of the cycle by multiple frequencies of chosen basis functions;
no consideration is given to coordinated combinations of element motions; and
no characterisation of motions is considered.

Similarly, input and editing tools in the current state of the art contain no elements associated with any of the additional features of the present invention.

Further, for any of the methods of the current state of the art, implementations provide no support for ensuring that the motion is physically correct.

Additionally, a desired motion from an artistic or compositional point of view may involve coordinated combinations of motions of individual elements. An example is a pirouette, which represents the coordinated motions of arms and legs at different degrees of synchronization or opposition and at offsetting amplitudes to be physically correct and/or visually pleasing. A simpler example is the swinging of arms, which involves the coordinated motions of shoulder, arm and hand elements to provide a physically plausible and/or visually pleasing overall motion. As for basis functions, coordinated combinations of element motions can be quantified in a number of ways. Examples of quantifiable elements are i) the speed of execution, ii) the magnitude of the overall motion, and iii) the relative magnitudes and phases of the elements of the motion.

Additionally, where an assembly is meant to represent a creature of complex inner state, such as a human, an animal, an alien, or a mechanical automaton, a motion involving some or all of an assembly's elements may relate to an emotional state or a mental intention ascribed to the represented creature. A given motion might then be characterized as, for example, an angry motion, a fatigued motion, a forced motion, or a joyful motion. Such characterizations are common in libraries of motion captured sequences, which are simple recordings of motion, not parameterized models.

With an underlying model comprised of quantifiable elements, those being basis functions or coordinated combinations of element motions, a given motion can be characterized as a point or a trajectory in a high-dimensional space, where each dimension represents one quantifiable element, and the position on that dimensional axis represents the quantity associated with that element. Thus a given motion or state of that motion at a given instant can be represented as a point in a high-dimensional space. A view showing motions as points or trajectories in a high-dimensional space provides a means to analyze and manipulate them in that space. For example, one point or series of points might represent a casual arm swing, while another point or series of points in the same high-dimensional space might represent a vigorous arm swing. A view into that space allows an artist or designer to study the relationship between the two motions, modify those motions, and to define new motions as points in that space in the neighborhoods of the existing points or along lines between them, for example. As another example, several points or series of points in a high-dimensional space may represent motions of a particular type, such as walking, but associated with different emotional states, such as anger, fatigue, or joy. A view into that space allows an artist or designer to study the relationships between those motions, modify those motions, and to define new motions as points in that space in the neighborhoods of existing points or as weighted combinations of existing points.

Accordingly, there remains a need in the art for i) structures and methods for containing or specifying complex cyclic motions as sets of related basis functions, with different periods, magnitudes and phases, ii) systems and methods for viewing, analyzing, and modifying such motion specifications at the level of basis functions, iii) systems and methods for viewing, analyzing, and modifying such motion specifications at the level of coordinated combinations of element motions, iv) systems and methods for viewing, analyzing, and modifying such motion specifications at the level of motion characterizations, and v) systems and methods for generating actuation and motion sequences for articulated assemblies from such a motion specification.

Embodiments of the invention may use separate controllers and viewers to view and manipulate a common motion specification model, where controllers and viewers are associated with particular conceptual spaces. Controllers and viewers process modification requests such that modifications done via one view modify the model i) within constraints set by the user, ii) based on a physical analysis of the modified motion, or iii) by defaults in the system, with those changes being reflected in the other views.

Embodiments of the invention may provide presentations for viewing, analyzing, and/or modifying a motion specification in different conceptual spaces, such as i) a Cartesian space with or without a time dimension and with or without a translation or travel component, ii) a space showing curves associated with a one or more periods or cycles of the motion, iii) a frequency space associated with the cycles of the motion, iv) a combined motion space showing which combinations of motion elements are present, their relationships, and possibly time intervals over which they are present, and v) a characterization space, which indicates to what degree motion of a certain type is present.

Embodiments of the invention may distribute components between the clients and servers in a client-server or peer-to-peer environment in order to allow those components to interact. In particular, when more than one user is working with any of the components, and the terrain is common between them, interactions between the components of different users may be processed in a common location. As an example, two assemblies moving over the same terrain that come into contact with each other accommodate that interaction in the form of obstructions to their movements and/or modifications to their motion specifications.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to the creation, analysis, and modification of motion specifications of articulated assemblies, such as robots, prostheses, and animated characters, and more specifically to the modeling of motions of articulated assemblies with rigid and/or flexible arbitrary shaped segments.

In accordance with an embodiment of the invention there is provided a method comprising:
establishing within a memory of a computer system a set of motion curves representing an articulated motion specification for an articulated assembly; wherein each curve comprises a set of basis functions defined by a plurality of magnitudes and a plurality of phases each associated with a predetermined magnitude of the plurality of magnitudes; and
executing with the computer system a motion simulator to generate simulated motion of the articulated assembly; wherein the simulated motion is established in dependence upon at least the set of motion curves representing the articulated motion specification for the articulated assembly.

In accordance with an embodiment of the invention there is provided a method comprising:
establishing within a memory of a computer system a motion specification for a first arbitrary articulated assembly; wherein
the motion specification of the first arbitrary articulated assembly was established by mapping a first plurality of assembly elements of the first arbitrary articulated assembly to second plurality of assembly elements of a second arbitrary articulated assembly for which a stable consistent motion specification defining the motion of the second arbitrary articulated assembly has been established.

In accordance with an embodiment of the invention there is provided a method comprising:
establishing within a memory of a computer system a set of motion curves representing an articulated motion specification for an articulated assembly; wherein each curve comprises a set of basis functions defined by a plurality of magnitudes and a plurality of phases each associated with a predetermined magnitude of the plurality of magnitudes; and specifying a change to a motion curve of the set of motion curves through the addition of a scaled impulse.

In accordance with an embodiment of the invention there are provided computer executable instructions stored upon a non-volatile non-transitory storage medium for execution by a microprocessor, the executable instructions when executed performing the steps of:
rendering to a user on a computer comprising the microprocessor a graphical user interface relating to a motion solver;
rendering to the user a graphical representation of a motion model relating an arbitrary articulated assembly rendered as at least one of a point and a trajectory in a high-dimensional space.

In accordance with an embodiment of the invention there is provided a method of animating an avatar comprising:
establishing motion of the avatar in dependence upon a motion model stored within a non-volatile non-transitory memory of a computer system, wherein the motion model comprises a set of motion curves representing an articulated motion specification for an articulated assembly; and wherein each curve comprises a set of basis functions defined by a plurality of magnitudes and a plurality of phases each associated with a predetermined magnitude of the plurality of magnitudes; and
executing with a microprocessor of the computer system a motion simulator to generate simulated motion of an articulated assembly associated with the avatar, wherein the simulated motion is established in dependence upon at least the set of motion curves representing the articulated motion specification for the articulated assembly.

In accordance with an embodiment of the invention there are provided computer executable instructions stored upon a non-volatile non-transitory storage medium for execution by a microprocessor, the executable instructions when executed performing the steps of:
rendering to the user an animation of an avatar wherein the motion of the character is established using a motion model established within the memory of a computer system, wherein
the motion model comprises a set of motion curves representing an articulated motion specification for an articulated assembly; and
each motion curve comprises a set of basis functions defined by a plurality of magnitudes and a plurality of phases each associated with a predetermined magnitude of the plurality of magnitudes; and
executing with the computer system a motion simulator to generate simulated motion of the articulated assembly, wherein the simulated motion is established in dependence upon at least the set of motion curves representing the articulated motion specification for the articulated assembly.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary block diagram of the components of a motion model according to an embodiment of the invention;

FIG. 2 depicts an exemplary block diagram of the components according to an embodiment of the invention;

FIG. 3 depicts an exemplary assembly view component of a Motion Editor according to an embodiment of the invention;

FIG. 4 depicts an exemplary mapping between two assemblies within a Motion Editor according to an embodiment of the invention;

FIG. 5 depicts an exemplary viewer for an assembly in a 3D space along with the terrain over which motion will take place according to an embodiment of the invention;

FIG. 6 depicts an exemplary viewer for an animation timeline according to an embodiment of the invention;

FIG. 7 depicts an exemplary viewer for motion basis functions as i) a function of time or phase, and ii) a set of basis function components, with magnitudes and phases according to an embodiment of the invention;

FIG. 8 depicts Motion Model points in a high-dimensional space according to an embodiment of the invention;

FIG. 9 depicts Motion Model points as fractions of exemplary points according to an embodiment of the invention;

FIG. 10 depicts a network environment within which embodiments of the invention may be employed; and

FIG. 11 depicts a wireless portable electronic device supporting communications to a network such as depicted in FIG. 8 and as supporting embodiments of the invention.

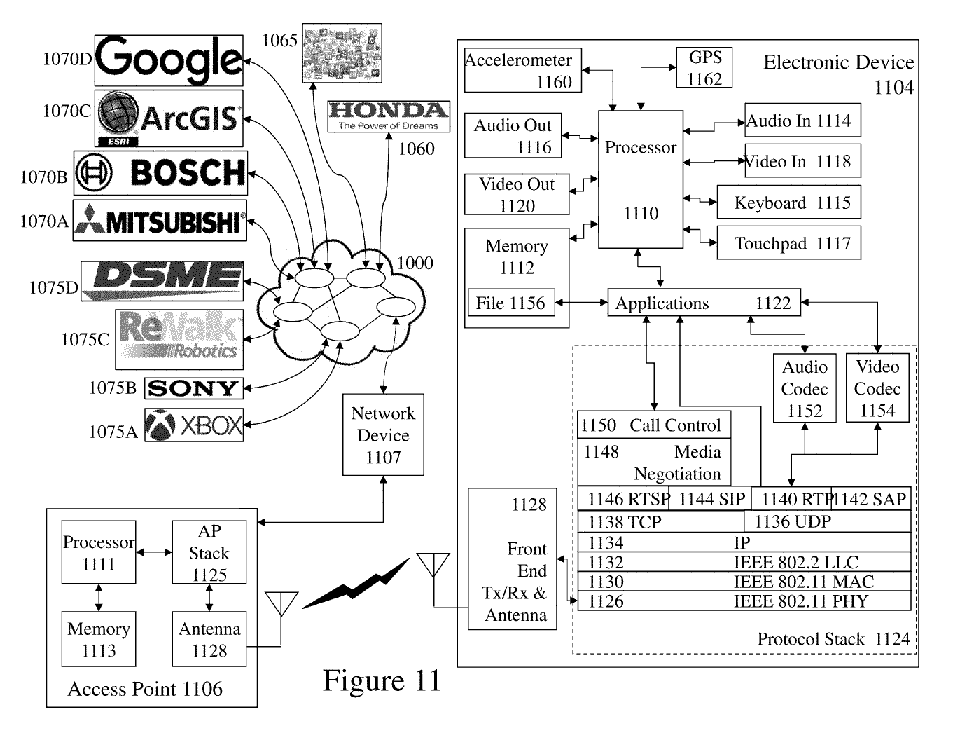

### DETAILED DESCRIPTION

This invention relates to the design and simulation of articulated assemblies, such as robots or animated characters, and more specifically to the model used to represent motions of such assemblies, and to the structures, systems and methods used to construct, view, analyze, and modify such a model.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) or “mobile electronic device” (commonly referred to as a mobile) as used herein and throughout this disclosure, refers to a wireless device used for communications and other applications that requires a battery or other independent form of energy for power. A PED may be recharged from a fixed interface to obtain power and also be connected to a wired communications interface. This includes devices, but is not limited to, such as a cellular telephone, smartphone, personal digital assistant (PDA), portable computer, pager, portable multimedia player, portable gaming console, a navigation system, laptop computer, tablet computer, a wearable device, an implanted device, a smart card, portable PoS, mobile PoS (mPoS), a motorized vehicle, a non-motorized vehicle, public transit vehicle, a vehicle guided by tracks and/or rails, an aircraft, a lighter-than-air device, a drone, a robot, an android, a biomedical device, an item of medical equipment and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a terminal, a gaming console, a digital set-top box, a base station, a wireless network access node/point, a network device, an automated teller machine (ATM), an automated banking machine (ABM), an analog set-top box, an Internet enabled appliance, an Internet enabled television, a PoS, a vending machine, a self-service device or system, a robotic system, an item of medical equipment, an entertainment system and a multimedia player.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™, Tumblr™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

A “computer server” (commonly known as a server) as used herein, and throughout this disclosure, refers to one or more physical computers co-located and/or geographically distributed running one or more services as a host to users of other computers, servers, PEDs, FEDs, etc. to serve the client needs of these other users. This includes, but is not limited to, a database server, file server, mail server, print server, web server, gaming server, virtual environment server, utility provider server, service provider server, goods provider server, financial server, financial registry server, personal server, and a Government regulatory server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED, FED and/or server.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility provider, a financial provider and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of service providers, members of a financial registry, members of utility providers, members of retailers, members of organizations, members of charities, men, women and children. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user profile information, and personal information. It may also include a user's biometric information, an estimation of the user's biometric information, or a projection/prediction of a user's biometric information derived from current and/or historical biometric information, and current-historical profile information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities.

“Geo-location” as used herein refers to, but is not limited, to the identification or estimation of the real-world geographic location of an object. In its simplest form geo-location involves the generation of a set of geographic coordinates and is closely related to the use of positioning systems, such as global positioning systems (GPS). However, other non-satellite based systems may be employed including for example geo-locating or positioning based upon a location engine exploiting wireless/radio frequency (RF) location methods such as Time Difference of Arrival (TDOA) where such information is accessible from multiple wireless transponders to allow triangulation. Alternatively, wireless base stations/cell towers can be employed to triangulate the approximate position through timing/power information of the multiple wireless base stations/cell towers which whilst subject to many sources of error beneficially supports indoor environments as well as outdoor environments where GPS satellite signals are weak or blocked. Other geo-location methods can include Internet and computer geo-location by associating a geographic location with the Internet Protocol (IP) address, MAC address, RFID, Wi-Fi access node etc. IP address location data can include information such as country, region, city, postal/zip code, latitude, longitude and time zone. Geo-location data may be defined in international standards such as ISO/IEC 19762-5:2008 or as defined by other standards or proprietary formats.

An “assembly” as used herein and through this disclosure refers to, but is not limited to, a combination of manufactured parts into a complete machine, structure or unit of a machine wherein the assembly comprises one or more segments which are coupled together via joints which have N degrees of freedom (0≤N≤6). The assembly may comprise actuators as segments (e.g. linearly extending segment), joints (e.g. motorised rotary joint), or actuators joining segments (e.g. a screw drive connecting two segments or a spring between two segments). An assembly may comprise elements such as wheels, tracks, etc. attached to segments at specific points including ends of segments etc. Examples of assemblies may include, but are not limited to, a bipedal android, a prosthetic hip replacement, an exoskeleton for a construction work, a robot with eight legs, a tracked vehicle, and a quadruped. Assemblies may be, but are not limited to, fully finished products in their own right, full simulations for direct viewing, a skeleton or exoskeleton of a product visualized with or without the body of the product, a mechanical representation of a human figure, a mechanical representation of an animal, and a mechanical representation of an imagined creature or vehicle.

“Terrain” (or relief or topographical relief) as used herein and through this disclosure refers to, but is not limited to, the vertical and/or horizontal dimensions of a surface upon which an articulated assembly moves through a fluid. Terrain accordingly, is used as a general term with respect to the physical geography, referring to the lay of the land, and is usually expressed in terms of the elevation, slope, and orientation of terrain features. Terrain may therefore refer to, but is not limited to, an area of land with air as the fluid, an area of the bottom of an ocean or other aqueous structure with water as the fluid, and an area of a surface from a solid or frozen material with a gaseous or liquid fluid.

A “segment” as used herein and through this disclosure refers to, but is not limited to, one of the parts (segments) into which something naturally separates or is divided. A segment may therefore be, but is not limited to, a division, a portion, or a section.

A “joint” as used herein and through this disclosure refers to, but is not limited to, a point at which parts of an artificial structure are joined. A joint may have N degrees of freedom (0≤N≤6) being within one frame of reference, X, Y, and Z linear axes together with roll, pitch, and yaw rotary axes around the X, Y and Z axes respectively. A joint may provide multiple axes within a single element or by combining several elements together. The X, Y, Z, roll, pitch and yaw axes for a joint may be renamed based upon their position and orientation within the articulated assembly.

A “physical law” (scientific law) as used herein and through this disclosure refers to, but is not limited to, a theoretical statement “inferred from particular facts, applicable to a defined group or class of phenomena, and expressible by the statement that a particular phenomenon always occurs if certain conditions be present.” Physical laws are typically conclusions based on repeated scientific experiments and observations over many years and which have become accepted universally within the scientific community. Such physical laws may include, but are not limited to, conservation of energy, conservation of momentum, conservation of angular momentum, conservation of mass, hydrodynamic continuity equation, gravity, and laws of motion (e.g. Newton, Euler).

“Motion” as used herein and through this disclosure refers to, but is not limited to, a change in position of an object over time. Motion may be described in terms of displacement, distance, velocity, acceleration, time and speed. Motion of a body is typically observed by attaching a frame of reference to an observer and measuring the change in position of the body relative to that frame.

A “combined motion” as used herein and through this disclosure refers to, but is not limited to, the coordinated motion of a set of assembly segments, where the set is identified, and it's quantifiable properties such as absolute and relative magnitudes and phases of the motions of segments or subsets of elements are defined. A combined motion may be given a name to relate it to identical or similar motions of a second assembly.

A “characterisation” as used herein and through this disclosure refers to, but is not limited to, the assigning of a mental inclination or an emotional state to a given motion, combined motion, or motion model. A characterisation may be quantifiable, or may be marked as either being present or not. A characterisation may be given a name to relate it to identical or similar properties of a second assembly or motion model.

A “basis function” as used herein and through this disclosure refers to, but is not limited to, a periodic time-domain function. One property of a basis function is its shape: it may be smooth, like a classic trigonometric sine or cosine, or angular, like a square wave or a saw-tooth wave. A second property of a basis function is its magnitude, measured either from a zero- or mid-line or from its minimum extreme to its maximum extreme. A third property of a basis function is its phase, measured either with respect to a defined point such as a zero crossing, or with respect to a defined point in another basis function, in which case the phase measurement is relative to that other basis function.

“Fourier Analysis” as used herein and through this disclosure refers to, but is not limited to, a method for representing a complex waveform as a series of basis functions. Basis functions are typically sinusoidal functions, but can be any period shape. The frequencies of basis functions used to represent a complex waveform typically form a harmonic series, but can be any sequence of frequencies.

The present invention defines i) a structure and methods for containing and specifying complex cyclic motions as sets of related basis functions, with different periods, magnitudes and phases, ii) systems and methods for viewing, analyzing, and modifying such motion specifications at the level of basis functions, iii) systems and methods for viewing, analyzing, and modifying such motion specifications at the level of coordinated combinations of element motions, iv) systems and methods for viewing, analyzing, and modifying such motion specifications at the level of motion characterizations, and v) systems and methods for generating actuation and motion sequences for articulated assemblies from such a motion specification.

Motion Model

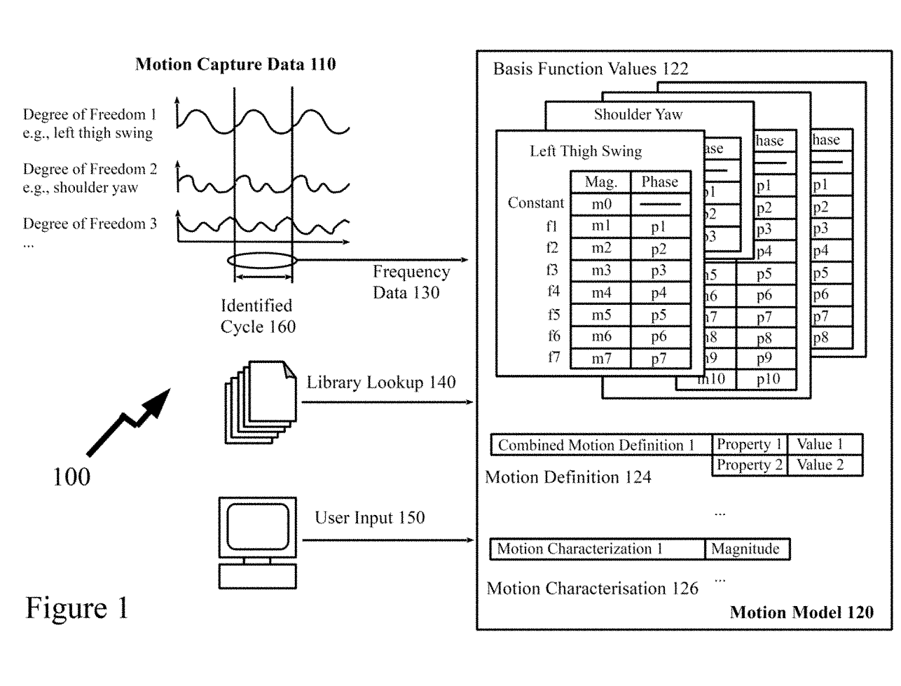

Referring to FIG. 1 there is depicted a block diagram of an embodiment of a motion model (MoMo) 100. The MoMo 100 is comprised of a set of elements corresponding to attributes of motion associated with particular assembly elements. As depicted such attributes are Motion Capture Data (MoCaDa) 110 within this exemplary embodiment wherein examples of degrees of freedom are i) the thigh swing attribute of the left leg element of an assembly representing a humanoid, and ii) the yaw attribute of the shoulders element of an assembly representing a humanoid. The motion attribute is comprised of a set of magnitudes and phases of basis functions associated with the assembly element. The embodiment of the invention depicted shows different numbers of basis functions for different attributes.

In FIG. 1, the paths from the MoCaDa 110 curves representing an example motion-captured frame sequence are shown as a way to initialize a motion model. Based upon analysis of the MoCaDa 110 an identified repetitious or pseudo-repetitious cycle is identified, Identified Cycle 160. This identified cycle 160 may then be subjected to frequency analysis, for example, yielding Frequency Data 130 which is then entered as part of the MoMo 120 as depicted by Basis Function Values 122. Other alternatives are to load a existing motion model from a library, Library Lookup 140, or to create a motion model from a blank state by either loading or defining an articulated assembly model, then assigning motions to its elements either by dragging it as a marionette or by inputting curve values, e.g. User Input 150.

Accordingly, in addition to the Basis Function Values 122 the MoMo 120 may also contain Motion Definition 124 and Motion Characterisation 126, for example. The motion specification in the MoMo 120 can be converted back to pose information for an articulated assembly, i.e., values for absolute and relative positional, and for joint degree of freedom values, by i) directly setting those values, when direct values are defined to be part of the motion model, or ii) deriving those values using known techniques of forward and inverse kinematics, when indirect values are defined to be part of the motion model. Examples of direct values are i) the absolute height of the assembly's root segment above a support surface, and ii) an angle value for a particular joint degree of freedom. Examples of derived or indirect values are i) the absolute center-of-mass of the assembly, which is an aggregated value depending on all of the assembly's massive elements, and ii) the angle of the forearm with respect to the ground, which is related to, but not equal to the angle of the elbow joint's one degree of freedom. Assembly positional values are computed from the motion model curves for regular phase intervals over the cycle represented in the model, at an interval size corresponding to the speed at which the cycle is to be executed, and the desired output frame rate. Positional value computation can continue beyond the duration of the cycle in the MoMo 120 by repeating that cycle indefinitely to produce a continuous, period motion of the subject articulated assembly.

The MoMo 120 may represent the motion of an entire articulated assembly, or a portion thereof. For example, one MoMo 120 may represent the motion of legs walking, while a second MoMo 120 may represent the motion of arms swinging. Those MoMo 120s may be extracted and/or created independently of each other and of the other elements in the assembly, and the poses representing the motion of the entire articulated assembly, including arms and legs, may be formed by combining pose computations from the two models.

Additionally, a desired motion from an artistic or compositional point of view may involve coordinated combinations of motions of individual elements, which will be referred to as a combined motion. An example is a pirouette, which represents the coordinated motions of arms and legs at different degrees of synchronization or opposition and at offsetting amplitudes, in total defining a motion that is physically correct and/or visually pleasing. A simpler example is the swinging of arms, which involves the coordinated motions of shoulder, arm and hand elements to provide a physically plausible and/or visually pleasing overall motion. As for basis functions, combined motions can be quantified in a number of ways. Examples of quantifiable elements are i) the speed of execution, ii) the magnitude of the overall motion, and iii) the relative magnitudes and phases of the elements of the motion.

A MoMo 120 may contain zero or more named combined motion definitions, such as depicted by Motion Definition 124 in FIG. 1 The quantification values for the quantifiable elements of each combined motion definition may be derived from segment motions defined via basis functions in the model, or set as reference values for use in evaluating corresponding combined motions in other motion models.

Additionally, where an assembly is meant to represent a creature of complex inner state, such as a human, an animal, an alien, or a mechanical automaton, a motion involving some or all of an assembly's elements may relate to an emotional state or a mental intention ascribed to the represented creature. A given motion might then be characterized as, for example, an angry motion, a fatigued motion, or a joyful motion. Such characterization are common in libraries of motion captured sequences, which are simple recordings of motion, not parameterized models.

A MoMo 120 may contain zero or more named characterisations, such as Motion Characterization 126 in FIG. 1. The magnitudes of the characterisations may be derived from motion or combined motion values, or set as reference values for use in evaluating corresponding characterisations in other motion models.

Motion Editor Architecture

Embodiments of the invention may use separate controllers and viewers to view and manipulate a common motion specification model, where controllers and viewers are associated with particular conceptual spaces. Controllers and viewers process modification requests such that modifications done via one view modify the model within constraints set by the user or by defaults in the system, with those changes being reflected in the other views.

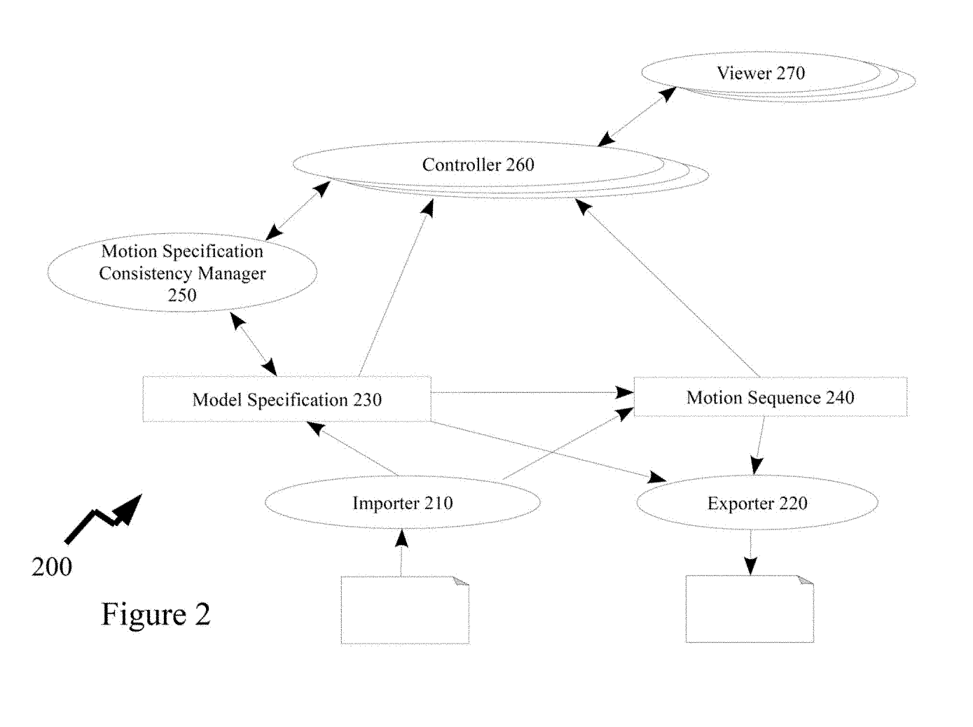

Now referring to FIG. 2 there is depicted a block diagram 200 of the components of an embodiment of the invention. The Model Specification 230 component holds a representation in computer memory of an assembly and a motions specification, a motion model. Each Viewer 270 component presents one of the possible views of the motion model. Each Controller 260 component manages the communication between the Model Specification 230 component and its corresponding Viewer component 270. The Motion Specification Consistency Manager 250 is a functional block used by the Controllers 260 to ensure that changes requested in a Viewer 270 are incorporated into the Motion Specification 230 in such a way that the motion specification remains consistent. Importer 210 and Exporter 220 components load and save model information in specific interchange formats, either as files or in direct communication with other systems.

Embodiments of the invention may distribute components between the clients and servers in a client-server or peer-to-peer environment in order to allow those components to interact. In particular, when more than one user is working with any of the components, and the terrain is common between them, interactions between the components of different users may be processed in a common location. As an example, two assemblies moving over the same terrain that come into contact with each other accommodate that interaction in the form of obstructions to their movements and/or modifications to their motion specifications.

Motion Editor Methods

Embodiments of the invention may provide presentations for creating, viewing, analyzing, and/or modifying a motion specification in different conceptual spaces, such as i) a Cartesian space with or without a time dimension and with or without a translation or travel component, ii) a space showing curves associated with a one or more periods or cycles of the motion of assembly elements, iii) a frequency space associated with the cycles of the motion, iv) a combined motion space showing which combinations of motion elements are present, their relationships, and possibly time intervals over which they are present, and v) a characterization space, which indicates to what degree motion of a certain type is present.

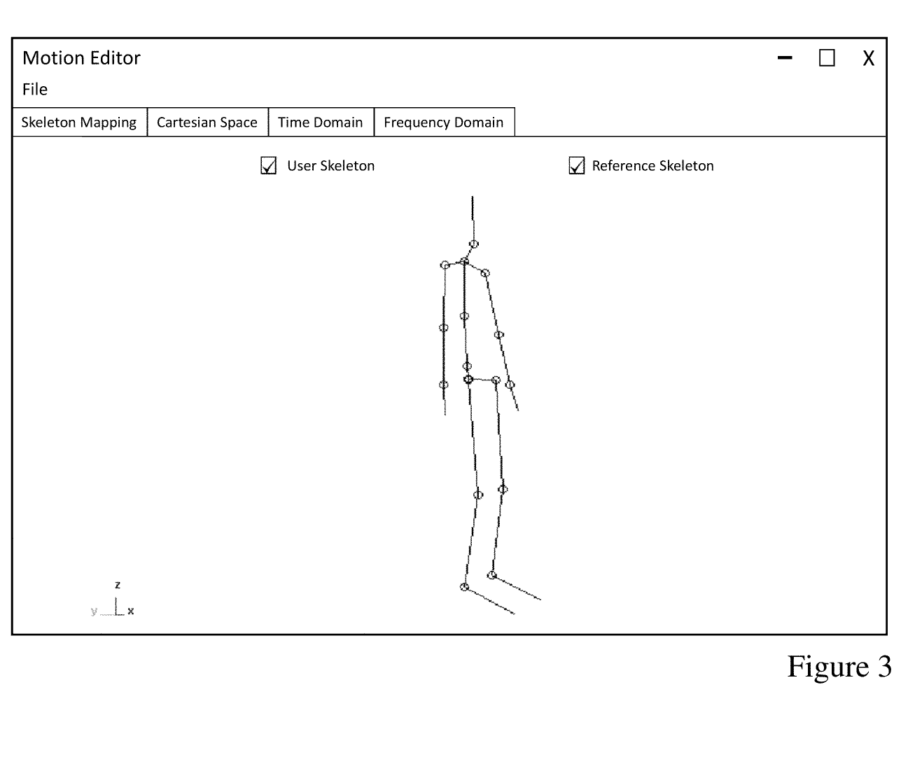

Referring to FIG. 3 there is depicted an assembly view component within a Motion Editor according to an embodiment of the invention. The subject assembly can be translated, rotated and scaled in the view, and the properties of its elements in whole or in part can be viewed and modified. Properties are comprised of i) dimensions for segments of an assembly, and ii) ranges of motion for degrees of freedom of joints. They may also include other properties relevant to a physical realization of the assembly, such as masses of segments, spring specifications for joint degrees of freedom, strength specifications for muscles, or actuators for joint degrees of freedom. This view may also show the motion of the assembly in place for all or part of a given motion specification. This view may also be used to modify the motion of the assembly, using the known technique of posing the assembly at particular points in time and capturing key frame state information.

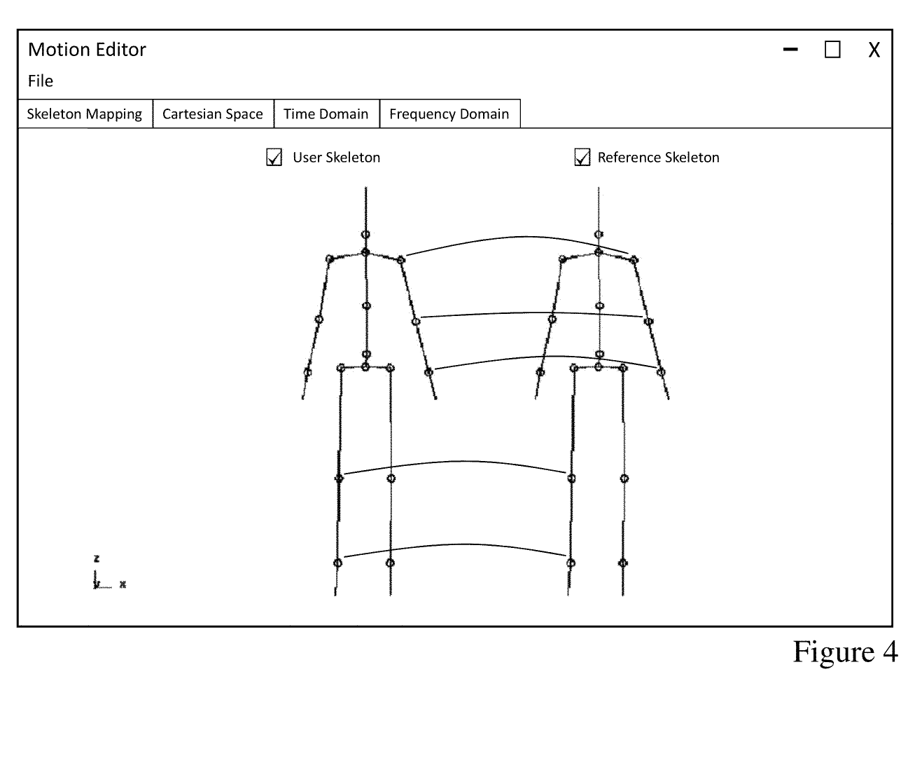

Now referring to FIG. 4 there is depicted a component within a Motion Editor according to an embodiment of the invention for viewing and modifying the mapping between two assemblies. In the embodiment shown, one assembly has been imported from another system, and one has been instantiated in the present invention from a previously defined template. Where the topologies of assemblies are known, the correspondence between elements may be done automatically from a previously defined template, otherwise correspondences can be defined in the view. Once these element correspondences have been established, other properties can be mapped between the assemblies, for example, the masses of segments can be transferred from one to the other or alternatively material, material properties, etc. Once mapping has been completed, editing of either assembly can cause corresponding changes in the other, or can be independently of the other assembly, obsoleting the mapping, after which mapping may be redone, or the assemblies may be allowed to differ.

Optionally, mapping may be undertaken across more than two assemblies ranging from a few through to tens, hundreds, thousands, or more. The mapping of properties may be established through mathematical processes such that parameters such as height, mass, arm length, leg length, etc. are varied by these mathematical processes such that whilst executing motion over a common terrain is performed each assembly does so slightly differently based upon its own parameters, just as a herd of animals, military unit, crowd, etc. would behave wherein each individual member of the multitude is physically different. Of course with a robot or android the variations between members of the multitude may be reduced significantly but still exist to reflect “real” production rather than perfect replicas which can also be modeled.

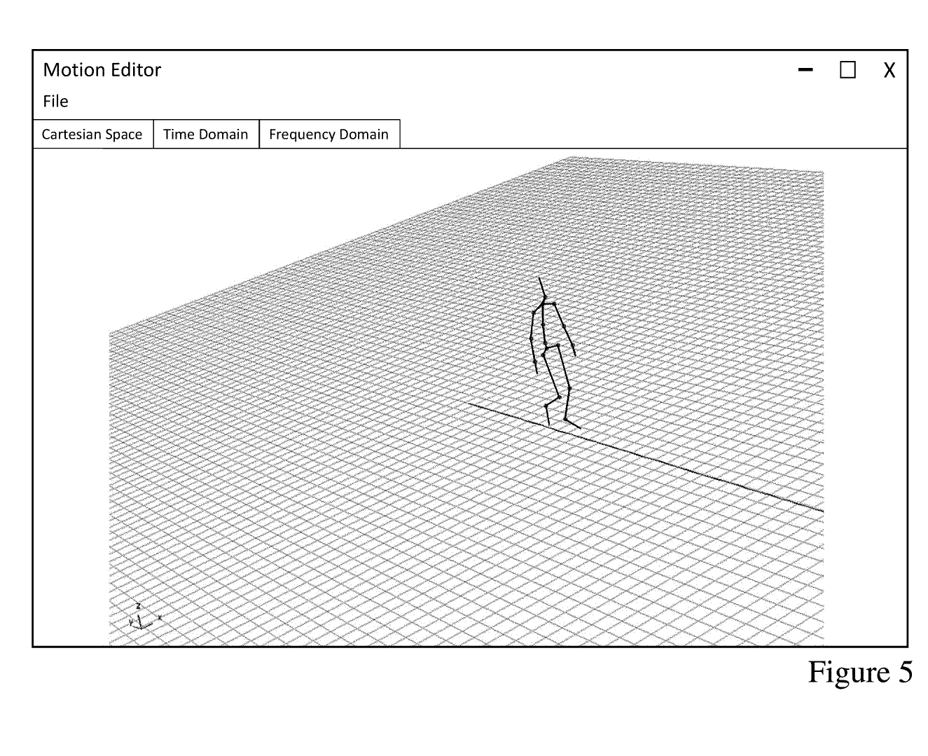

FIG. 5 depicts a viewer component for an assembly in a 3D space along with the terrain over which motion will take place. An embodiment of the present invention may include the character mesh, landscape, lighting and other elements of the view, as one would see in an animation editor. The view shows the position of the assembly through time, which can be animated, stepped, or stopped at any instant. The set of properties of the terrain may comprise, but not be limited to:
its altitude,
its static coefficient of friction,
its dynamic coefficient of friction.

The set of physical laws associated with a particular instance of an assembly and its motion may comprise, but not be limited to:
the magnitude of the gravitational constant.

For terrain and physical law solution properties, as well as storing values for them for times as described above, values may be stored for those times for different locations. One embodiment of the invention may define only one value for some of the solution properties for all locations. A second embodiment of the invention may define a grid of fixed granularity over the range of the terrain and store values for some of the solution properties for each polygon defined by the grid. A third embodiment may define an irregular grid and store values for some of the solution properties for each polygon defined by the grid. Not all terrain and physical law solution properties need be treated the same way. One embodiment may store single values for some solution properties, and values for other solution properties for each polygon defined by a grid.

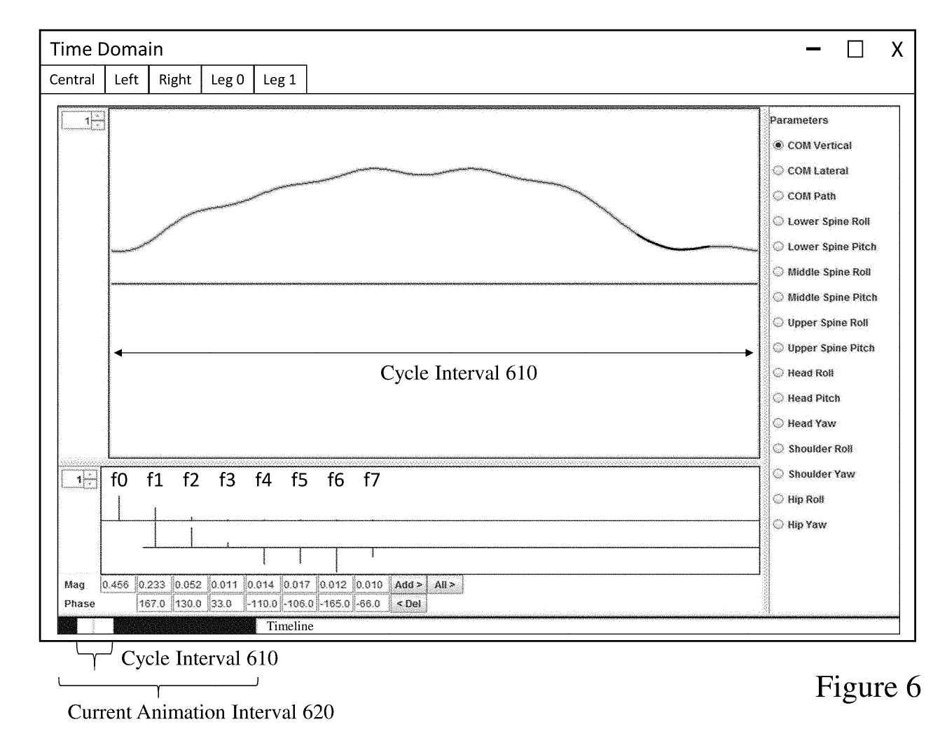

Referring to FIG. 6 there is depicted the view of an animation timeline. In the embodiment shown, the timeline shows i) the extent of a currently considered animation, Current Animation Interval 620, which may include many cycles of a cyclic motion and any number of acyclic elements, and ii) the time period representing a single cycle of the complex cyclic motion of the assembly, Cycle Interval 610, in this case one stride of the legs and swing of the arms beginning when the right foot leaves the ground, travels to its next point of contact with the ground, supports the centre of mass of the assembly over that contact point, and reaches the stage where it is ready to leave the ground again. The timeline in an embodiment of the invention may allow i) the cycle beginning and end points to be set, ii) repetitions of the cycle to be created to extend the animation duration, iii) the insertion of acyclic elements, and other properties which affect how cyclic and acyclic elements will be combined to form an entire animation sequence. Associated with the timeline may also be VCR-style controls for playing, pausing, reversing, etc., the current animation. As described above, the cycle interval may be defined by a user by specifying begin and end times, or it may be calculated through an analysis of an existing animation sequence, e.g., using the contact times of feet with the ground, or the period of swing of the arms or legs.

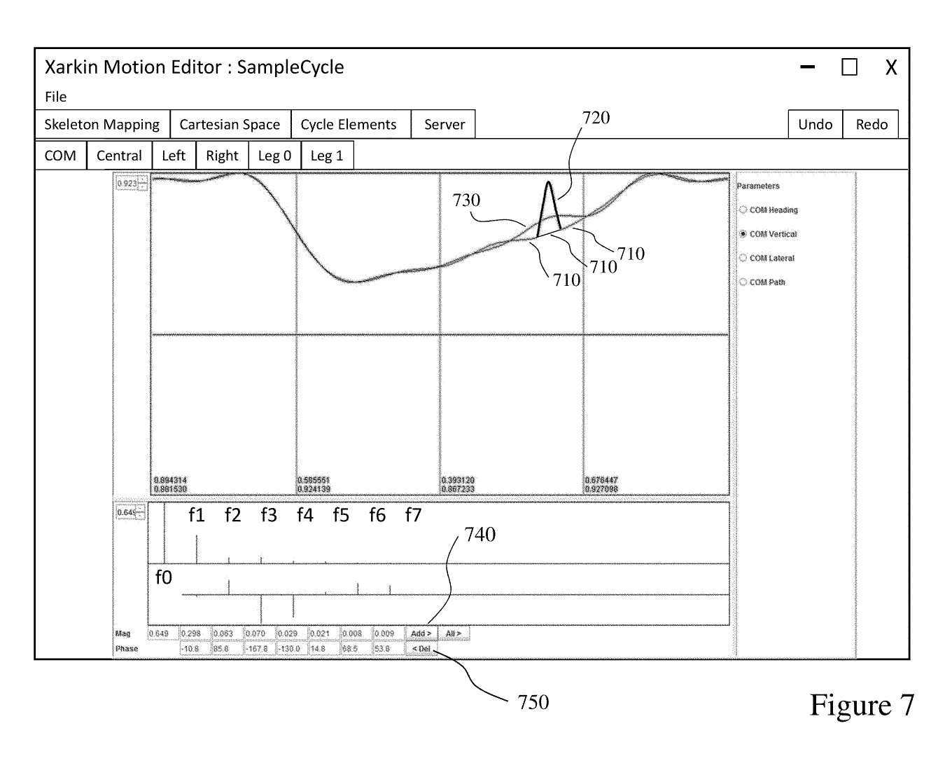

Now referring to FIG. 7 there is depicted a view of a segment of motion information, which may be a single cycle of the assembly's motion. In the embodiment of the present invention shown, the graph shows the motion of a single property, in this instance the altitude of the centre of mass of the assembly. The graph allows a user to modify the shape of the curve by clicking and dragging it at a chosen point. The modification is done by adding a smooth impulse to the curve, such as a raised cosine. The portion of the graph modified, i.e., the width of the raised cosine, depends on a width parameter associated with modifications. The width parameter may be set using a text field or using the wheel of a mouse. A curve formed by adding the raised cosine to the original motion curve is considered to be the curve desired by the user. As for an original input curve, the desired curve is approximated by a sum of some number of basis functions such as sine waves: the basis function magnitudes and phases are derived from the desired curve using a convolution such as a discrete Fourier transform. Basis functions other than sine curves could be used to represent the frequency information in the motion curve. Accordingly, the lower curve 710 represents an original portion of the segment motion information, the upper curve segment 720 represents the modified segment motion information whilst the dashed curve 730 shows what the curve will be when the user releases the mouse button, i.e., the curve as it is possible to represent it using the existing number of basis functions. Through the use of the Add> button 740 and <Del button 750 in the frequency graph, the user can increase or decrease the number of basis functions associated with the motion curve. The user can then vary the number of basis functions to use, and drag curve points to produce a desired curve shape.

The magnitudes and phases of the basis functions are shown in the frequency view of the curve at the bottom of FIG. 7. The motion curve in an embodiment of the invention is stored in computer memory as a sequence of positional information associated with specific times or, in the case of animation, frame numbers. The motion of the entire assembly is stored as a set of motion curves. In all cases, the positional information may be recorded as relative to an external reference point, e.g., the origin, or relative to the assembly's centre of mass.

The magnitudes and phases of each frequency component of the motion curve can also be modified using the frequency view, as shown in the view of one embodiment of the present invention at the bottom of FIG. 7. The number of frequency components to be used can also be set using that frequency view. It may be set to some maximum number of components, which may be a parameter to the embodiment of the invention, or a constant built into the embodiment, or it may be incrementally increased or decreased. The intention is to allow a user, i.e., a motion designer, the freedom to control the shape and complexity of an assembly's motion both via the shape of the motion as a whole or via the magnitudes and phases of its frequency components. Accordingly, a user may employ a small number of components for developing the desired overall motion as computing complexity reduced and then increase the number of components to view final motions. Similarly, the number of components may be varied in dependence upon other factors, including but not limited to, the computing capabilities of the computer system rendering the motion, characteristics of the display upon which the rendered motion is displayed, network connectivity if the rendering is associated with an online game etc. Accordingly, it would be evident that according to the capabilities of the system that avatars and other elements may be rendered based upon the stored information relating to the avatar construction/design etc. and the resolution of the motion established through the number of frequency components employed.

The frequency information of a curve in an embodiment of the invention is stored in computer memory as a set of magnitudes and phases for the set of frequencies associated with the curve. The frequency information for the entire assembly is stored as a set of frequency information sets for each of the curves of motion of the assembly. In all cases, the frequency information may be recorded as absolute, i.e., with respect to a global time clock, or relative to the duration of a cycle to which the motion curve involved is associated.

When a modification of one element of a motion specification is done, the other elements of the specification are considered constraints on the modification. A modification refers to a change in a numeric value associated with an element, such as the angle of a joint. Each element may be assigned bounds over which it can vary, and a cost for changing it. As a modification of one element is requested, typically, but not constrained to be, via a user interface action, the modified value requested for that element in combination with the unmodified values of all of the other elements are considered the desired state and assigned a cost of zero. That zero-cost state, however, may be inconsistent. For example, a request to straighten a bent knee may cause part of a foot to penetrate the ground. A consistent state that responds to the request to straighten the knee may straighten it less that requested, may rotate the whole leg at the hip to keep the heel from penetrating the ground, may raise the torso, or may partially do all or some of these things. An embodiment of the invention must be able to respond to the request in a way that produces a consistent state. One consistent state is always available: it is the state before any modification of elements was performed, however remaining in that state implies not responding to the change request. Because it has not responded to the request, that consistent state, has a non-zero cost: the value of the element where a modification has been requested is not in the requested state.

An embodiment of the invention may respond to the request in the following manner. Consider a test state to be one where any number of element values have been modified such that the state is consistent. The cost function may be defined as a squared error sum over all of the element values, where the contribution to the cost from each element is the square of the difference between its numeric value representing in a test state and the numeric value in the zero-cost state, multiplied by some scaling factor for that element. A test state with a low cost is more desirable than one with a high cost in that it has responded more to the modification request and/or modified other element values less. A search for the most desirable state, given the modification requested, can be done using known techniques of simulated annealing, or gradient search, where gradients are computed for each modifiable element value. The search may be performed on a uniprocessor, or it may be distributed over a multiprocessor. The computation involved may be represented in matrix form or as functions of small numbers of variables. The search may be time-limited in order to provide a rapid response, meaning that the most desirable state found may not be the most desirable possible, but a best effort given the time and compute resources available.

One view of test states is that any state is consistent, but that some element values may be assigned very high cost values if they are beyond bounds set either by a user or by system default. Considering the example above, a heel penetrating the ground was considered to be inconsistent, but as an alternative it could have instead been assigned a very high cost value by using, for example, a high scaling factor for the cost for any state of the heel which puts it below ground level. In that way, smooth curves, and so smooth gradients can still be followed to find a more desirable state. Viewed in the context of a real physical system, a heel striking the ground with great force may be expected to deform the ground (terrain) and so be considered a valid state. Similarly, a knee joint may be considered to be in an inconsistent state if the knee is twisted, because knees normally only bend, i.e., have one degree of freedom. A state with a twisted knee, if considered inconsistent, may be excluded from the search. It may alternatively be considered a high-cost consistent state and included in the search. Viewed in the context of a real physical system, a twisted knee may, for example, indicate that the assembly has been damaged.

The above technique is similarly applied to the conversion of a motion specification, including cyclic and acyclic elements, to an animation sequence through time and following a path over the specified terrain. At each instant in time, the desired state is computed from the cyclic and acyclic elements of the motion specification for that instant, and the direction, position and velocities contained in the path specification. The terrain specification represents constraints on the motion of the assembly, where that specification may lead to the classification of a test state as inconsistent or high cost, as discussed above.

An embodiment of the present invention may also include in the cost calculations for test state costs associated with adherence to the set of physical laws specified. Variation of numeric values representing element states from numeric values for physically possible states for those elements can be treated the same way as values associated with the motion specification. Similarly, physically impossible states may be considered inconsistent and excluded from the search, or assigned a high cost and included in the search, as discussed above.

As an alternative to the above, an embodiment of the present invention may calculate state costs with respect to the set of physical laws specified and make them available to the user. In that way, a user may see the effects and severity on physical correctness of modifications made to a motion model, without the calculations of those physical effects directly affecting the content of the motion model.

An embodiment of the present invention may also include in the cost calculations for test state costs associated with magnitudes of forces and torques, and with energy expenditure. Actuators may have limited abilities to apply forces and torques, and a system may have a limited energy supply making energy expenditure an important consideration. The cost for a given state may include, for example, squared values for forces and torques, each multiplied by a scaling factor, to create a gradient toward lower forces and torques. Similarly, the cost for a given state may include, for example, the scaled squared value for the energy required to reach that state from the one in the previous time instant, to create a gradient toward lower energy expenditure.

In all cases, evaluating test states and modifying element values to find a low-cost desirable state may include contributions from the present invention itself, as described above, or from a user of the invention who is presented with test state information and can indicate or input directly element value modifications that he or she reasons may result in improvement.

With an underlying model comprised of quantifiable elements, those being basis functions, combined motions, or characterizations, a given motion can be characterized as a point or a trajectory in a high-dimensional space, where each dimension represents one quantifiable element, and the position on that dimensional axis represents the quantity associated with that element. Thus a given motion or state of that motion at a given instant can be represented as a point in a high-dimensional space. A view showing motions as points or trajectories in a high-dimensional space provides a means to analyze and manipulate them in that space. For example, one point or series of points might represent a casual arm swing, while another point or series of points in the same high-dimensional space might represent a vigorous arm swing. A view into that space allows an artist or designer to study the relationship between the two motions, modify those motions, and to define new motions as points in that space in the neighborhoods of the existing points or along lines between them, for example. As another example, several points or series of points in a high-dimensional space may represent motions of a particular type, such as walking, but associated with different emotional states, such as anger, fatigue, or joy. A view into that space allows an artist or designer to study the relationships between those motions, modify those motions, and to define new motions as points in that space in the neighborhoods of existing points or as weighted combinations of existing points.

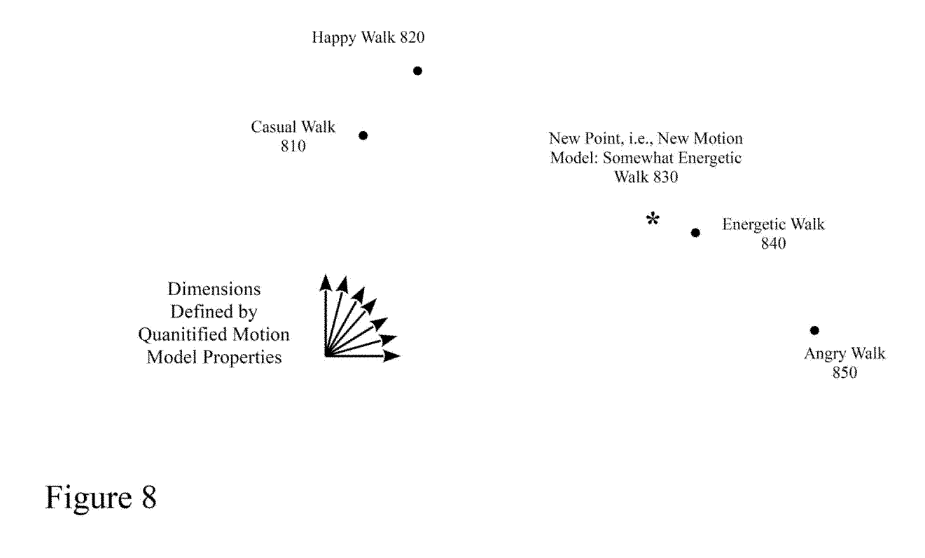

Now referring to FIG. 8 there is depicted an example of a set of points in a high-dimensional space representing different types of walk. The representation in the example shows dimension axes, which may be all or a subset of model properties, as a set of vectors whose graphical positions may be under user control. A user may define a new point in the depicted space which will have properties that are established based upon weightings applied to those points already existing within the high-dimensional space so that the new point will be more like the exemplary points it is close to and least like the exemplary points it is distant from. As an actual high-dimensional space cannot be rendered for representation upon a two-dimensional (2-D) or three-dimensional (3-D) display, the position of the new point is defined as a function of the positions of the exemplary points, such as a weighted average.

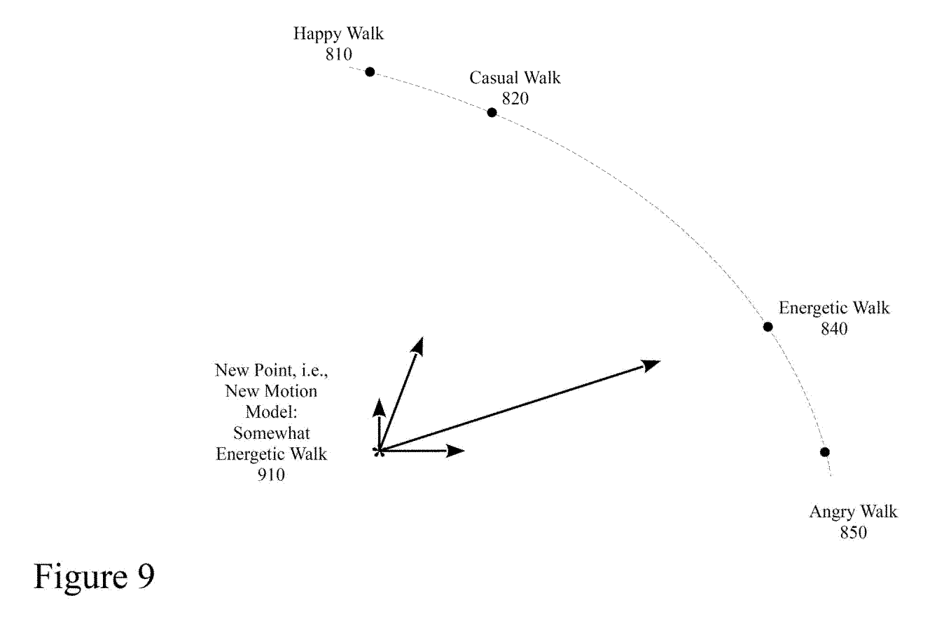

FIG. 9 shows the same set of high-dimensional points as FIG. 8, but using a representation that puts a marker for a newly defined point at the centre of a set of rays corresponding to dimensions defined by exemplary points in the space. Methods of computing distances in the representation shown in the figure would be obvious to one skilled in the art. One embodiment of the present invention may, for example, define a maximum distance as an integer multiple of the greatest distance between any pair of examplary points used to define the space. For each exemplary point, the distance of the head of the vector from the marker for the new point to that exemplar would be proportional to the ratio of the distance of the new point to that exemplar to the maximum. By defining distances in that way, a vector, for example, from the marker for a new point that nearly reaches its corresponding exemplar means that the new point is very close to that exemplar, i.e., the new motion model specifies motion for the articulated assembly which closely matches the motion specified by the exemplar. The representation would correspondingly show vectors from the marker for the new point toward each of the other exemplars where the position of the vector head would conform to the distance described above.

Referring to the representation depicted in FIG. 9, a user may drag a vector head along the line between the marker for the new point and the exemplar between that marker and the exemplar. Dragging that vector head defines a position for the new point in the underlying space to be somewhere along the line defined by the unmodified new point and the exemplar. Hence, dragging that vector head onto the exemplar point moves the new point exactly to the exemplar's position in space, while dragging it toward the vector tail moves it directly away from the corresponding examplar. When one vector head is dragged, the other arrows, pointing toward the other exemplars, are adjusted in length to adhere to the description above, i.e., each is proportional to the ratio of the distance of the modified new point to the exemplar associated with the vector to the maximum.

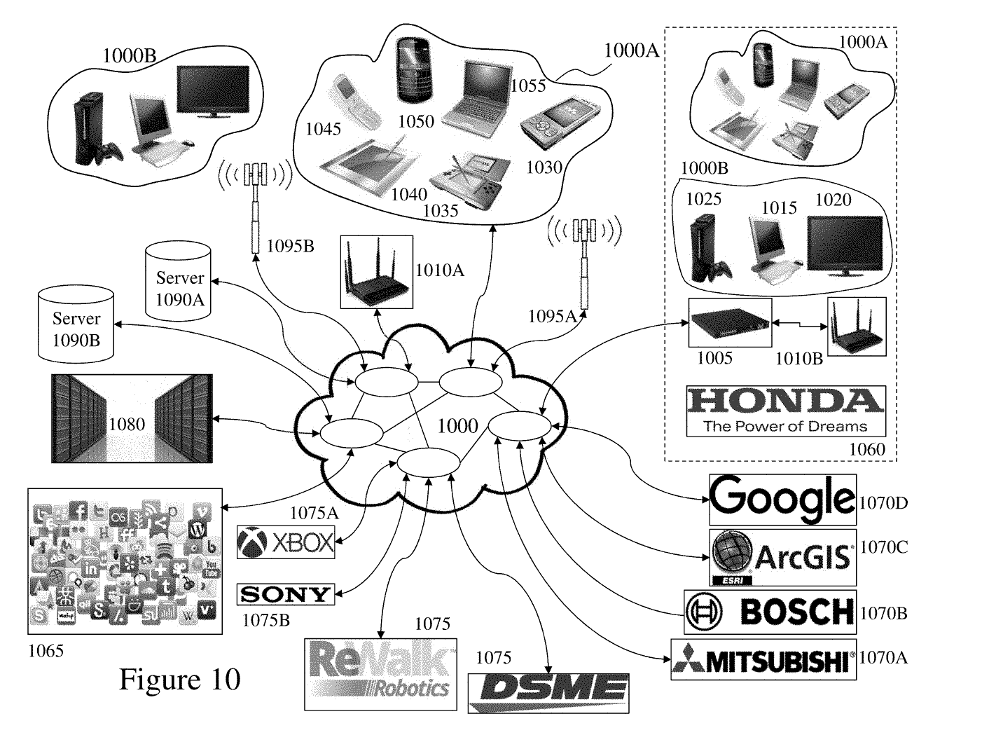

Now referring to FIG. 10 there is depicted a network environment 1000 within which embodiments of the invention may be employed supporting Motion Editor Systems and Motion Editor Applications/Platforms (MES-MEAPs) according to embodiments of the invention. Such MES-MESAPs, for example, supporting multiple communication channels, dynamic filtering, etc. As shown first and second user groups 1000A and 1000B respectively interface to a telecommunications network environment 1000. Within the representative telecommunication architecture, a remote central exchange 1080 communicates with the remainder of a telecommunication service providers network via the network environment 1000 which may include for example long-haul OC-48/OC-192 backbone elements, an OC-48 wide area network (WAN), a Passive Optical Network, and a Wireless Link. The central exchange 1080 is connected via the network environment 1000 to local, regional, and international exchanges (not shown for clarity) and therein through network environment 1000 to first and second cellular APs 1095A and 1095B respectively which provide Wi-Fi cells for first and second user groups 1000A and 1000B respectively. Also connected to the network environment 1000 are first and second Wi-Fi nodes 1010A and 1010B, the latter of which being coupled to network environment 1000 via router 1005.

Second Wi-Fi node 1010B is associated with commercial service provider 1060, e.g. Honda™, comprising other first and second user groups 1000A and 1000B. Second user group 1000B may also be connected to the network environment 1000 via wired interfaces including, but not limited to, DSL, Dial-Up, DOCSIS, Ethernet, G.hn, ISDN, MoCA, PON, and Power line communication (PLC) which may or may not be routed through a router such as router 1005.

Within the cell associated with first AP 1010A the first group of users 1000A may employ a variety of PEDs including for example, laptop computer 1055, portable gaming console 1035, tablet computer 1040, smartphone 1050, cellular telephone 1045 as well as portable multimedia player 1030. Within the cell associated with second AP 1010B are the second group of users 1000B which may employ a variety of FEDs including for example gaming console 1025, personal computer 1015 and wireless/Internet enabled television 1020 as well as cable modem 1005. First and second cellular APs 1095A and 1095B respectively provide, for example, cellular GSM (Global System for Mobile Communications) telephony services as well as 3G and 4G evolved services with enhanced data transport support. Second cellular AP 1095B provides coverage in the exemplary embodiment to first and second user groups 1000A and 1000B. Alternatively the first and second user groups 1000A and 1000B may be geographically disparate and access the network environment 1000 through multiple APs, not shown for clarity, distributed geographically by the network operator or operators. First cellular AP 1095A as show provides coverage to first user group 1000A and environment 1070, which comprises second user group 1000B as well as first user group 1000A. Accordingly, the first and second user groups 1000A and 1000B may according to their particular communications interfaces communicate to the network environment 1000 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 1000A may form associations either through standards such as IEEE 802.15 and Bluetooth as well in an ad-hoc manner.

Also connected to the network environment 1000 are Social Networks (SOCNETS) 1065, first and second original equipment manufacturers (OEMs) 1070A and 1070B respectively, e.g. Mitsubishi™ and Bosch™, first and second third party service providers 1070C and 1070D respectively, e.g. ArcGIS™ and Google™. Also connected to the network environment 1000 are first and second entertainment system providers 1075A and 1075B respectively, e.g. Microsoft Xbox™ and Sony™ together with first and second robotic exoskeleton manufacturers, e.g. ReWalk Robotics™ and DSME™ (division of Daewoo), together with others, not shown for clarity. Accordingly, a user such as commercial service provider 1060 engages with multiple users, e.g. other commercial and/or individuals to provide dynamic motion systems to them. Accordingly, these devices, systems, etc. exploiting MES-MESAPs may access resources including those within their own organization, e.g. commercial service provider 1060 (Honda™), together with first and second OEMs 1070A and 1070B respectively, e.g. Mitsubishi™ and Bosch™, or other service providers such as first and second service providers 1070C and 1070D respectively, ArcGIS™ and Google™. For example, first and second entertainment system providers 1075A and 1075B respectively, e.g. Microsoft Xbox™ and Sony™, may exploit MES-MESAPs either to generate motion of characters, equipment, robotic systems etc. within the gaming environment or control/manage/design a device/system associated with a gaming environment for example. Alternatively, first and second robotic exoskeleton manufacturers, e.g. ReWalk Robotics™ and DSME™, may exploit MES-MESAPs according to embodiments of the invention to design/manage/control exoskeleton systems.

For example, a user with a robotic exoskeleton hip replacement may have the hip replacement exploiting MES-MESAP features according to embodiments of the invention. Electronic device 1104 may, for example, be a PED and/or FED and may include additional elements above and beyond those described and depicted. Also depicted within the electronic device 1104 is the protocol architecture as part of a simplified functional diagram of a system 1100 that includes an electronic device 1104, such as a smartphone 1055, an access point (AP) 1106, such as first AP 1010, and one or more network devices 1107, such as communication servers, streaming media servers, and routers for example such as first and second servers 1090A and 1090B respectively. Network devices 1107 may be coupled to AP 1106 via any combination of networks, wired, wireless and/or optical communication links such as discussed above in respect of FIG. 8 as well as directly as indicated. Network devices 1107 are coupled to network environment 1000 and therein Social Networks (SOCNETS) 1065, first and second original equipment manufacturers (OEMs) 1070A and 1070B respectively, e.g. Mitsubishi™ and Bosch™ first and second third party service providers 1070C and 1070D respectively, e.g. ArcGIS™ and Google™. Also connected to the network environment 1000 are first and second entertainment system providers 1075A and 1075B respectively, e.g. Microsoft Xbox™ and Sony™ together with first and second robotic exoskeleton manufacturers, e.g. ReWalk Robotics™ and DSME™ (division of Daewoo), together with others, not shown for clarity.

The electronic device 1104 includes one or more processors 1110 and a memory 1112 coupled to processor(s) 1110. AP 1106 also includes one or more processors 1111 and a memory 1113 coupled to processor(s) 1110. A non-exhaustive list of examples for any of processors 1110 and 1111 includes a central processing unit (CPU), a digital signal processor (DSP), a reduced instruction set computer (RISC), a complex instruction set computer (CISC) and the like. Furthermore, any of processors 1110 and 1111 may be part of application specific integrated circuits (ASICs) or may be a part of application specific standard products (ASSPs). A non-exhaustive list of examples for memories 1112 and 1113 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 1104 may include an audio input element 1114, for example a microphone, and an audio output element 1116, for example, a speaker, coupled to any of processors 1110. Electronic device 1104 may include a video input element 1118, for example, a video camera or camera, and a video output element 1120, for example an LCD display, coupled to any of processors 1110. Electronic device 1104 also includes a keyboard 1115 and touchpad 1117 which may for example be a physical keyboard and touchpad allowing the user to enter content or select functions within one of more applications 1122. Alternatively, the keyboard 1115 and touchpad 1117 may be predetermined regions of a touch sensitive element forming part of the display within the electronic device 1104. The one or more applications 1122 that are typically stored in memory 1112 and are executable by any combination of processors 1110. Electronic device 1104 also includes accelerometer 1160 providing three-dimensional motion input to the process 1110 and GPS 1162 which provides geographical location information to processor 1110.

Electronic device 1104 includes a protocol stack 1124 and AP 1106 includes a communication stack 1125. Within system 1100 protocol stack 1124 is shown as IEEE 802.11 protocol stack but alternatively may exploit other protocol stacks such as an Internet Engineering Task Force (IETF) multimedia protocol stack for example. Likewise, AP stack 1125 exploits a protocol stack but is not expanded for clarity. Elements of protocol stack 1124 and AP stack 1125 may be implemented in any combination of software, firmware and/or hardware. Protocol stack 1124 includes an IEEE 802.11-compatible PHY module 1126 that is coupled to one or more Front-End Tx/Rx & Antenna 1128, an IEEE 802.11-compatible MAC module 1130 coupled to an IEEE 802.2-compatible LLC module 1132. Protocol stack 1124 includes a network layer IP module 1134, a transport layer User Datagram Protocol (UDP) module 1136 and a transport layer Transmission Control Protocol (TCP) module 1138.

Protocol stack 1124 also includes a session layer Real Time Transport Protocol (RTP) module 1140, a Session Announcement Protocol (SAP) module 1142, a Session Initiation Protocol (SIP) module 1144 and a Real Time Streaming Protocol (RTSP) module 1146. Protocol stack 1124 includes a presentation layer media negotiation module 1148, a call control module 1150, one or more audio codecs 1152 and one or more video codecs 1154. Applications 1122 may be able to create maintain and/or terminate communication sessions with any of devices 1107 by way of AP 1106. Typically, applications 1122 may activate any of the SAP, SIP, RTSP, media negotiation and call control modules for that purpose. Typically, information may propagate from the SAP, SIP, RTSP, media negotiation and call control modules to PHY module 1126 through TCP module 1138, IP module 1134, LLC module 1132 and MAC module 1130.

It would be apparent to one skilled in the art that elements of the electronic device 1104 may also be implemented within the AP 1106 including but not limited to one or more elements of the protocol stack 1124, including for example an IEEE 802.11-compatible PHY module, an IEEE 802.11-compatible MAC module, and an IEEE 802.2-compatible LLC module 1132. The AP 1106 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 1104 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 10 depicts an Electronic Device 1104, e.g. a PED, wherein one or more parties including, but not limited to, a user, users, an enterprise, enterprises, third party provider(s), wares provider(s), service provider(s), original equipment manufacturer, designer, design studio, component supplier, etc. may engage in one or more activities with a MES-MESAP according to embodiments of the invention.

For example, a user's prosthesis, such as a leg for example, may be designed and specified using a MES-MESAP according to an embodiment of the invention. Such a prosthesis would be typically powered, what the inventor refers to as an active exoskeleton, rather than an unpowered (passive exoskeleton) prosthesis such as a hip replacement. Accordingly, the prosthesis rather than operating in fixed predetermined modes such as within the prior art, e.g. walk, climb stairs, may operate in an adaptive mode wherein the current context/environment of the user and the desired result for the user are inputs to the Motion Editor/MES-MESAP according to an embodiment of the invention and accordingly the active exoskeleton responds to the context/environment/desired result in real time. In this manner the Motion Editor/MES-MESAP may establish a terrain specification of the solution property space based upon the user's current location and a mode specification of the solution property space based upon either the user's current mode, e.g. walk, or a selection made by the user, e.g. step up or walk and step-up.

Additionally, the MES-MESAP may monitor sensors associated with the modeled and implemented system so that the MES-MESAP obtains feedback directly or this may also be fed back to remote databases for assessment versus the desired (target) motion in order to identify common restrictions/limitations that the dynamic motion system presents to users. Accordingly, remote servers may identify limitations, unforeseen circumstances, segment/joint aging characteristics etc. Such factors may be introduced into lifetime assessments of dynamic motion systems whether exoskeletons, androids, remote devices, etc. as well as providing unique characteristics to simulated environments such that the behaviour of an “old” android may be different from a “new” android of the same design.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. The method according to claim 25 comprising:
establishing within a memory of a computer system a set of motion curves representing an articulated motion specification for an articulated assembly; wherein each curve comprises a set of basis functions defined by a plurality of magnitudes and a plurality of phases each associated with a predetermined magnitude of the plurality of magnitudes; and
executing with the computer system a motion simulator to generate simulated motion of the articulated assembly; wherein the simulated motion is established in dependence upon at least the set of motion curves representing the articulated motion specification for the articulated assembly.

2. The method according to claim 1, wherein
at least one of:
the articulated motion specification is derived from a series of poses for an articulated assembly; and
the articulated motion specification is derived from a subset of a series of poses for an articulated assembly where a user employs a graphical user interface to specify the bounds of the subset interval.

3. The method according to claim 1, wherein
a measure of correctness of at least one of the simulated motion and the articulated motion specification is determined with respect to a set of physical laws established for the environment of the simulation; and
at least one of the measures of correctness is presented to the user and an automated routine associated with the motion simulator which modifies the articulated motion specification in dependence upon the measure of correctness.

4. A method according to claim 1, wherein
the articulated motion specification includes one or more definitions for combined motions and values for the quantization parameters for each combined motion corresponding to the motion curves associated with the elements in the combination.

5. The method according to claim 1, wherein
the articulated motion specification includes one or more characterisations of the motion corresponding to an assigned at least one of a mental state and an emotional state to an articulated assembly to which the articulated motion specification relates.

6. The method according to claim 25 comprising:
establishing within a memory of a computer system a motion specification for a first arbitrary articulated assembly; wherein
the motion specification of the first arbitrary articulated assembly was established by mapping a first plurality of assembly elements of the first arbitrary articulated assembly to second plurality of assembly elements of a second arbitrary articulated assembly for which a stable consistent motion specification defining the motion of the second arbitrary articulated assembly has been established.

7. The method of claim 6, wherein
the mapping can be viewed and modified through a graphical user interface.

8. The method of claim 6, wherein
the articulated motion specification is maintained internally consistent when one of its elements is modified by modifying other elements containing redundant information.

9. The method of claim 6, wherein
consistency of the articulated motion specification is maintained by either modifying corresponding curve basis functions when a motion curve is changed or modifying a motion curve when a corresponding basis function is changed.

10. The method according to claim 6, wherein
consistency of the stable consistent motion specification defining the motion of the second arbitrary articulated assembly is maintained by modifying a set of motion curves defining the motion of elements of the second arbitrary articulated assembly by changing parameters associated with one or more of the motion curve basis functions.

11. The method according to claim 6, wherein
the stable consistent motion specification defining the motion of the second arbitrary articulated assembly is maintained with respect to a defined set of external elements comprising at least one of physical laws and barriers to movement by modifying one or more motion curves of a plurality of motion curves and their associated basis functions when a modification is made to a predetermined motion curve of the plurality of motion curves.

12. A method according to claim 11, wherein
the articulated motion specification includes one or more definitions for combined motions and values for the quantization parameters for each combined motion corresponding to the motion curves associated with the elements in the combination.

13. The method according to claim 11, wherein
the articulated motion specification includes one or more characterisations of the motion corresponding to an assigned at least one of a mental state and an emotional state to an articulated assembly to which the articulated motion specification relates.

14. The method according to claim 26 comprising:
establishing within a memory of a computer system a set of motion curves representing an articulated motion specification for an articulated assembly; wherein each curve comprises a set of basis functions defined by a plurality of magnitudes and a plurality of phases each associated with a predetermined magnitude of the plurality of magnitudes; and
specifying a change to a motion curve of the set of motion curves through the addition of a scaled impulse.

15. The method according to claim 14, wherein
at least one of:
the scaled impulse is a raised cosine curve; and
the portion of the motion curve affected established in dependence upon user input.

16. A method according to claim 15, wherein
the articulated motion specification includes one or more definitions for combined motions and values for the quantization parameters for each combined motion corresponding to the motion curves associated with the elements in the combination.

17. The method according to claim 15, wherein
the articulated motion specification includes one or more characterisations of the motion corresponding to an assigned at least one of a mental state and an emotional state to an articulated assembly to which the articulated motion specification relates.

18. The computer executable instructions according to claim 27 performing the steps of:
rendering to a user on a computer comprising the microprocessor a graphical user interface relating to a motion solver;
rendering to the user a graphical representation of a motion model relating an arbitrary articulated assembly rendered as at least one of a point and a trajectory in a high-dimensional space.

19. The computer executable instructions according to claim 18, wherein
the user through the graphical user interface can define a new motion model by choosing a plurality of at least one of new points and new trajectories within the high-dimensional space that are at least one of existing at least one of points and trajectories within the high-dimensional space and within a predetermined distance of existing at least one of points and trajectories within the high-dimensional space.

20. The computer executable instructions according to claim 18, wherein
the at least one of a point and a trajectory in a high-dimensional space is an existing stable consistent motion specification for the arbitrary articulated assembly.

21. The computer executable instructions according to claim 18, wherein
the motion model is established in dependence upon a fractional quantities of exemplary models, each exemplary model being an existing stable consistent motion specification for the arbitrary articulated assembly.

22. The computer executable instructions according to claim 18, wherein
the user through the graphical user interface can define a new motion model by choosing a plurality of at least one of new points and new trajectories within the high-dimensional space that are at least one of existing at least one of points and trajectories within the high-dimensional space and within a predetermined distance of existing at least one of points and trajectories within the high-dimensional space.

23. The method according to claim 26 comprising:
establishing motion of the avatar in dependence upon a motion model stored within a non-volatile non-transitory memory of a computer system, wherein the motion model comprises a set of motion curves representing an articulated motion specification for an articulated assembly; and wherein each curve comprises a set of basis functions defined by a plurality of magnitudes and a plurality of phases each associated with a predetermined magnitude of the plurality of magnitudes; and
executing with a microprocessor of the computer system a motion simulator to generate simulated motion of an articulated assembly associated with the avatar, wherein the simulated motion is established in dependence upon at least the set of motion curves representing the articulated motion specification for the articulated assembly.

24. The computer executable instructions according to claim 27 performing the steps of:
rendering to the user an animation of an avatar wherein the motion of the character is established using a motion model established within the memory of a computer system, wherein
the motion model comprises a set of motion curves representing an articulated motion specification for an articulated assembly; and
each motion curve comprises a set of basis functions defined by a plurality of magnitudes and a plurality of phases each associated with a predetermined magnitude of the plurality of magnitudes; and
executing with the computer system a motion simulator to generate simulated motion of the articulated assembly, wherein the simulated motion is established in dependence upon at least the set of motion curves representing the articulated motion specification for the articulated assembly.

25. A method of animating an avatar comprising executing a process upon a microprocessor based computer system.

26. A method of animating an avatar comprising executing a process upon a microprocessor based computer system.

27. Computer executable instructions stored upon a non-volatile non-transitory storage medium for execution by a microprocessor, the executable instructions when executed performing the steps of:
animating an avatar.
